(19) United States
(12) Patent Application Publication
(10) Pub. No.: US 2019/0279322 A1
(43) Pub. Date: Sep. 12, 2019

(54) SYSTEM, METHOD, AND COMPUTER PROGRAM PRODUCT TO PROVIDE QUANTITATIVE AND QUALITATIVE ASSESSMENT OF DATA ANALYSIS AND INFORMATION HANDLING IN AN ORGANIZATION

(71) Applicant: Christopher Robert Lew, Laurel, MD (US)

(72) Inventor: Christopher Robert Lew, Laurel, MD (US)

(21) Appl. No.: 16/295,373

(22) Filed: Mar. 7, 2019

Related U.S. Application Data
(60) Provisional application No. 62/640,368, filed on Mar. 8, 2018.

(51) Int. Cl. G06Q 50/20; G06F 9/54; G06Q 10/06

(52) U.S. Cl. CPC G06Q 50/2057; G06Q 10/06393; G06F 9/547

(57) ABSTRACT

A system, method, and computer program product to provide quantitative and qualitative assessment of data analysis and information handling in an organization via an exercise scenario. The system provides a plurality of tools/interfaces through which participants and proctors communicate with the exercise environment. Each participant interaction with the scenario is automatically tracked and a quantitative assessment of individual and team performance is provided via a metrics tool.

### CROSS-REFERENCE TO RELATED APPLICATION

This application claims the benefit of priority of U.S. provisional application No. 62/640,368, filed Mar. 8, 2018, the contents of which are herein incorporated by reference.

### BACKGROUND OF THE INVENTION

The present invention relates to data analysis and information handling functions within organizations, and more particularly to systems and methods to evaluate and train organizations on analysis and information handling.

Presently, analysis of information such as all-source intelligence, strategic factors, or competitive intelligence, and handling or communicating that information within an organization is largely a qualitative process that is difficult to evaluate and quantify. Furthermore, most training is done through on-the-job experience and it is difficult to simulate that experience through existing solutions.

It is also greatly affected by organizational culture, information handling constraints, and communication barriers that impede the passage of needed information within and between organizations. These constraints are difficult to simulate in existing solutions. Consequently, most current training is done on-the-job and there are no current quantitative measures used to judge the performance of analytical behavior.

While collective training events for organizations exist, such as war gaming, qualitative and quantitative assessments for individual participants and the organization's analytical behavior remain difficult to capture.

As can be seen, there is a need for an improved system and method to provide an environment to capture quantitative evaluations of data analysis behavior in a repeatable and scalable method.

### SUMMARY OF THE INVENTION

In one aspect of the present invention, a computerized system for use by a data analysis and information handling training system to provide a quantitative assessment of data analysis and information handling operations of a team over a network platform is disclosed. The computerized system includes a computer having a user interface and a scenario database storing scenario data defining an exercise scenario and a corpus of non-machine processable information. An event manager tool is configured to provide an interface with the scenario database. A request for information (RFI) tool is configured to receive a plurality of requests for information (RFIs) from a participant during the training scenario. An analytical management tool provides an interface through which the participant can adjust one or more of an access level to the scenario data, a team's composition; and a team's capability. An analytical tools suite is configured to provide the participant one or more tools for analyzing the scenario data. A metrics tool is configured to receive raw participant data reflecting an action the participant takes with each of the event manager tool, the RFI tool, the analytical management tool, and the analytical tools suite, and automatically providing the quantitative assessment of the data analysis and information handling operations of the team.

In some embodiments, the event manager tool also includes an interface to allow a proctor to distribute scenario data from the scenario database, one or more kill switches to control the exercise scenario, and a communications interface configured to manage communications within the exercise scenario.

In other embodiments, the analytical tools suite may include a timeline tool configured to provide a work space to order the scenario data according to a temporal sequence. The analytical tools suite may also include a hypothesis comparison tool configure to provide a workspace for the participant to formulate a hypothesis and assess a validity of the hypothesis by arranging the scenario data as empirical evidence in support or refutation of the hypothesis. The hypothesis comparison tool may provide an interface for the participant to assign a numerical value to each piece of a relevant scenario data element, determine a score of the hypothesis in a structured manner, and compare the score to determine which of a plurality of hypotheses is most accurate.

In other embodiments, the analytical tools suite includes a geospatial tool configured to allow the participant to place one or more scenario data elements on a map in order to determine one of a location and a spatial relationship between the one or more scenario data elements.

In yet other embodiments, the analytical tools suite may also include a document analysis tool configured to allow participants to sort, filter, rank, and arrange the scenario data. The document analysis tool may also include an interface configured for the participant to select a part of one or more scenario data elements to be displayed, assign a priority to the one or more scenario data elements, and designate the one or more scenario data elements for processing by one or more other tools within the analytical tool suite.

In yet other embodiments, the analytical management tool includes a virtual wallet, configured to decrement a predetermined credit value for a change in one or more of an access level to the scenario data, a composition of the team; and a team capability.

In yet other embodiments, the network platform includes a JavaScript web development framework client in communication with a content delivery network (CDN) implemented in a distributed network of proxy servers and data centers. The network platform may also include an authentication identity service provider configured to provide a JSON Web Token (JWT) as an identity authentication. The network platform may further include an application program interface (API), hosted on a cloud service provider site that is configured to coordinate a plurality of HTTP requests and the JWT access token for each of the plurality of HTTP requests.

In yet another embodiment, the computerized system includes a real-time communications functionality provided by an external real-time communication service provider.

These and other features, aspects and advantages of the present invention will become better understood with reference to the following drawings, description and claims.

### BRIEF DESCRIPTION OF THE DRAWINGS

FIG. 1 is a flowchart illustrating an implementation of a training scenario environment to providing qualitative and quantitative assessments;

FIG. 2 is a continuation of the flow chart of FIG. 1;

FIG. 3 is a continuation of the flow chart FIG. 2;

FIG. 4 is a continuation of the flow chart FIG. 3;

FIG. 5 is a system architecture diagram for the training scenario environment;

FIGS. 6A and 6B are a rubric for an automated performance scoring; and

FIG. 7 is a diagram of a platform infrastructure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved system, method, and computer program product to evaluate and train organizations on analysis and information handling through a simulated war game. The present invention allows for participants to conduct analysis of information in a simulated real-world scenario. Aspects of the invention also provide for quantitative and qualitative assessments of organizational and participant performance during the scenario.

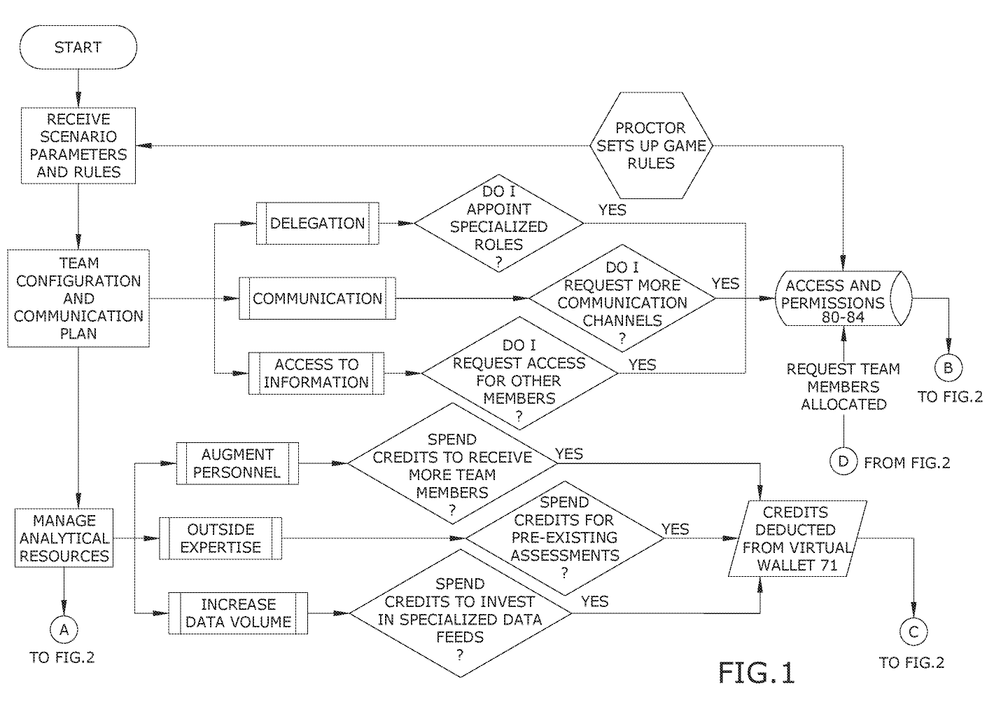

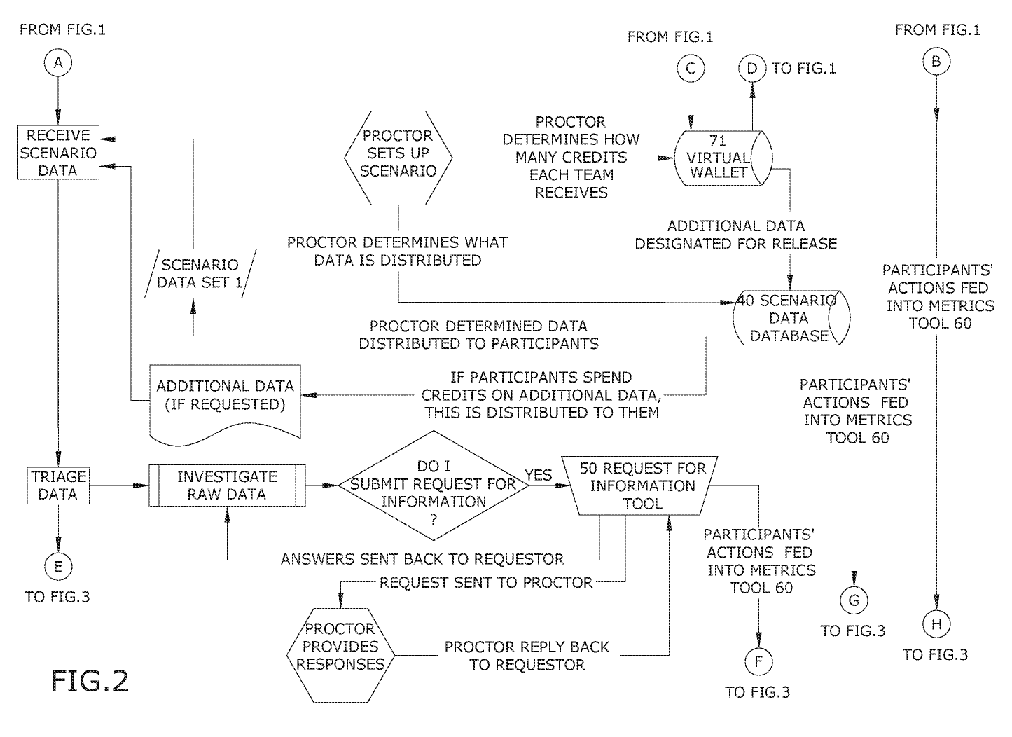

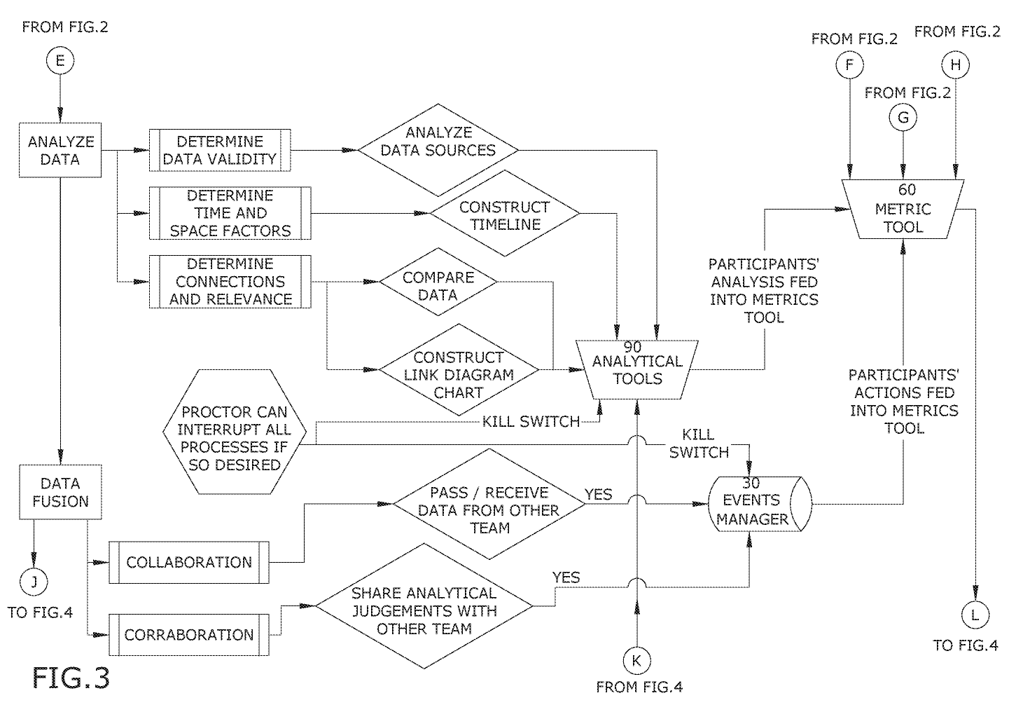

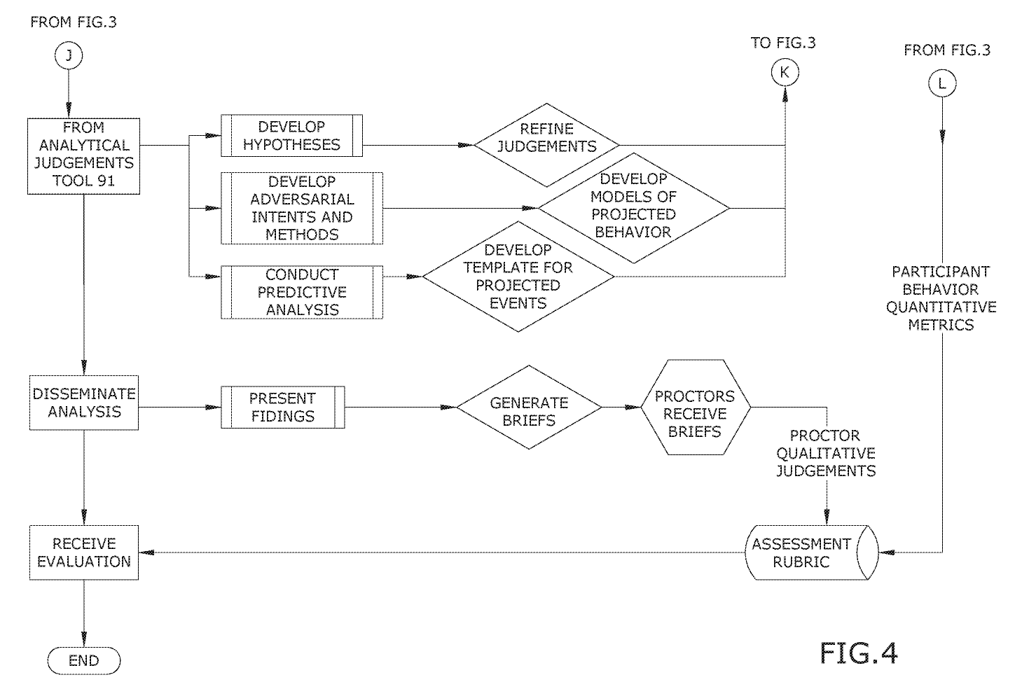

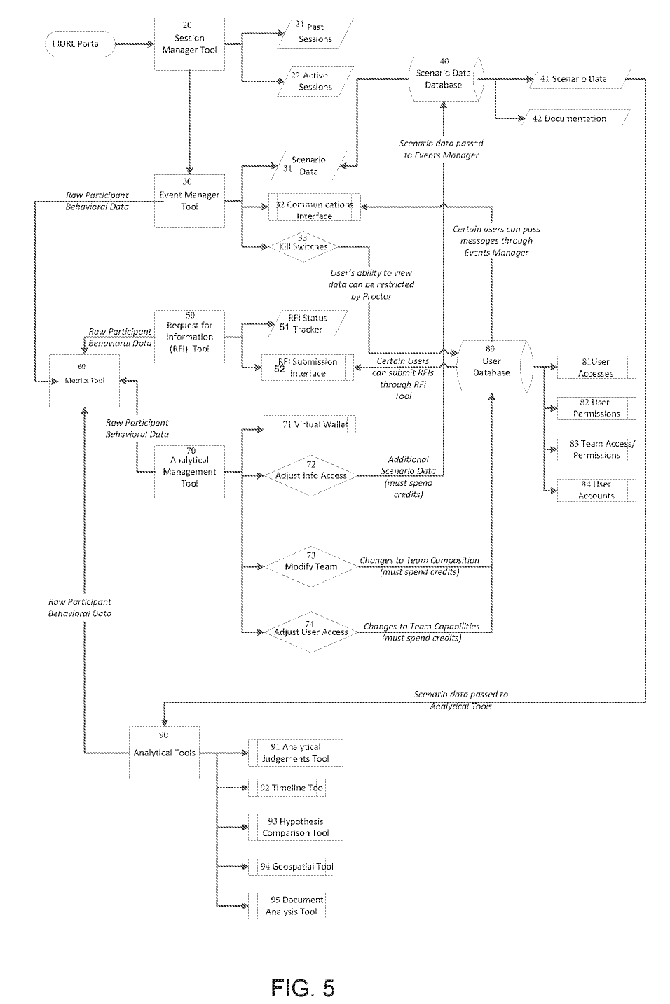

As seen in reference to the drawings of FIGS. 1-5, a system according to the present invention provides hosting and control of a collective training scenario environment by means of an online platform 10. Major components of the platform 10 include a session manager tool 20; an event manager tool 30; a scenario database 40; a request for information (RFI) tool 50; a metrics tool 60; an analytical management tool 70; a user database 80; and analytical tools 90. The platform 10 also provides for information transmission within the training environment, and communication between participants.

The platform 10 monitors and tracks participant activities and behavior through the metrics tool 60 in order to provide quantitative metrics which are used for evaluation purposes. The platform's ability to automatically track participant communications, assess how accurately the participants analyze individual information reports, and other activities the participants are performing are key components in being able to identify strengths and weaknesses of organizational units or individuals in order to determine a level of competency or to leverage further training.

A system according to the present invention includes three components that work together to train and evaluate organizations or individuals in data analysis. These parts consist of a war game scenario; a rubric for assessing analytical behavior through various quantitative and qualitative metrics; and an online platform which administers the scenario by controlling the flow of information and recording participant behavior.

The first component is a war game scenario in which participants are put through a simulation of the data analysis process. Participants are presented a real-world crisis scenario that they view through a hand-crafted data stream. Their task is to determine what will happen in the near future. Simultaneously, they face constraints such as limited ways to communicate or access restrictions to certain data types. These are meant to deliberately hamper the participants' ability to conduct effective data analysis, hence this element being a war game scenario.

The data is configured around specific topics based off the nature of the scenario. For instance, a military scenario can consist of military intelligence reports, operational data, news articles, doctrine, etc. This corpus of data is deliberately configured to not be machine processable, e.g. algorithms or statistics; instead, it must be collated and analyzed by a human being. The data also contain contextual information such as source, content, and collection methods, some of which are deliberately inaccurate, deceptive, or misleading, which forces participants to determine the validity of these reports before using the information contained therein.

The war game is fundamentally a collaborative exercise. The participants are divided into teams with different functions and specialties. For instance, one team might specialize in cyber issues and will receive technical cyber reports, while another team might focus on political risk and will receive policy documents and diplomatic cables. In this way, teams will receive different information and have different tasks, resulting in differing approaches to analyzing the data. However, in order to conduct effective data analysis to understand the entire situation, they will have to properly manage the process, share information, and leverage their unique perspectives, otherwise each team will produce inaccurate and fragmented conclusions.

As seen in reference to the drawings of FIGS. 1-5, a system according to the present invention provides hosting and control of a collective training scenario environment by means of an online platform 10. The platform 10 may be accessed via a universal resource locator (URL) portal 11. The session manager 20 provides access to one or more of a past session 21 or an active session 22.

The event manager tool 30 allows one or more Proctors to create, manage, and execute a customized scenario via an input linkage 31 to the scenario database. The proctors design a real-world scenario that challenges individuals and organizations to conduct analysis in order to discern the situation. The proctors input scenario data 41, which consists of the reports which simulate a real world scenario into the database through an interface on the platform 10. The proctors can then set a timeline for events, designate what and when information is passed to the participants, and set certain rules regarding communication and information handling that will be used to assess analytical and management performance and behavior through the events manager tool 30.

A communications interface 32 facilitates communications during a war game session. The event manager tool 30 may also include one or more kill switches 33 to permit the proctors to interrupt actions during the course of the session. By way of non-limiting examples, the kill switch 33 may be configured in a targeted mode to limit access to certain reports, transmission of information to or from an individual participant, groups of participants, or certain data sources. The kill switch 33 may also be configured in a global mode to suspend all activities within the training scenario in order to suspend the exercise for administrative or game-related reasons.

The scenario database 40 houses the scenario information which may include scenario data 41 and scenario documentation 42. The scenario data 41 are the pieces of information that make up the game itself and may include: open source news reports, intelligence reports, cyber intrusion forensics reports, internal operations reports, map coordinates, graphics, photos, spreadsheets, etc. Participants receive this information through the events manager tool 30 in order to try to interpret and understand what is happening during the game. This information is intentionally fragmented and, in some cases, misleading.

The scenario documentation 42 may include: a description of the rules, user manual for the platform, list of access and permissions at the start of the game, organizational chart for the current session, description of the events before the start of the game, definitions and acronyms, etc. This information is meant to help set the stage for game and for participants to navigate the online platform and play the game correctly. This information is meant to be accurate and comprehensive for the user.

Scenario data is uploaded into the scenario data database 40. Communications from proctor to participant, game end/start, and kill switches 33 may be pre-staged by the proctor through the events manager tool 30. One or more scenario rules may be set by scenario proctor by creating teams within the session manager tool 20 and establishing initial user and team access and permissions in the user database 80, user access 81, user permissions 82, team access and permissions 83.

The event manager tool 30 allows the proctor to set up what will occur during the game including when the game starts and ends, when and which documents get passed to the participants, and to employ the kill switches 33. The event manager tool 30 also allows both the proctor and participants to communicate with each other during the game.

The RFI tool 50 allows participants and proctors to exchange and manage requests for information or RFIs submitted during the training scenario. Requests for information are questions posed by the participant to the proctor regarding conduct of the game, software issues, game issues, and analytical issues. The RFI tool 50 includes an RFI status tracker 51 which indicates submitted RFIs and progress of the RFI. By way of non-limiting example, the RFI tracker 51 may display the RFI and an indication of its progress, such as submitted; received; complete. An RFI submission interface 52 provides a portal through which participants submit RFIs and the proctors respond.

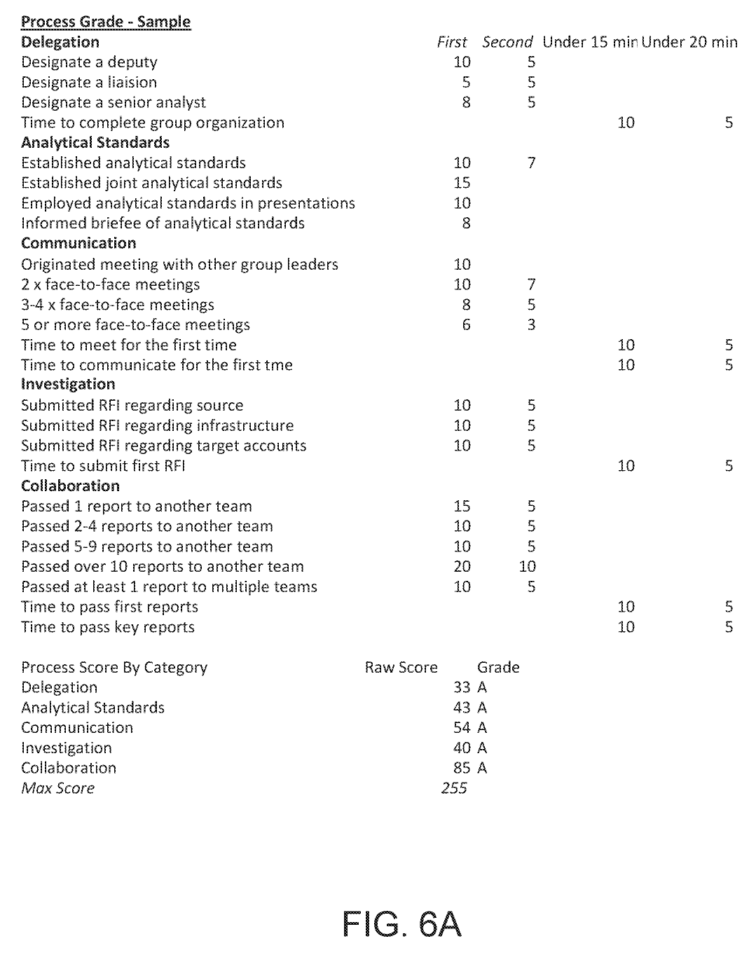

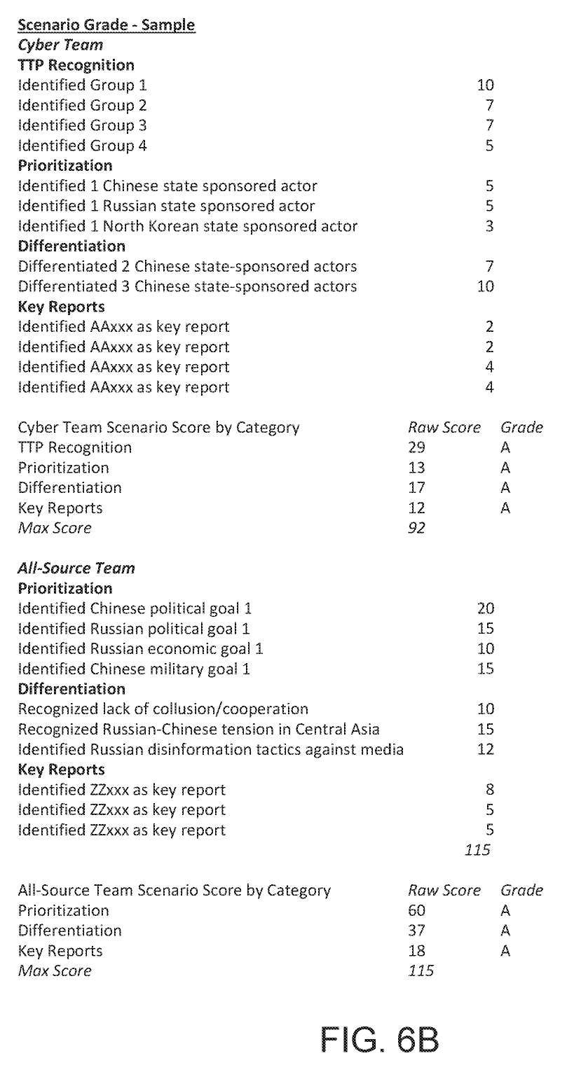

The metrics tool 60 is configured to receive raw participant behavior data from the event manager tool 30; the RFI tool 50, the analytical management tool 70; and the analytical tool suite 90. Participants use the platform 10 in order to be evaluated on their ability to manage and conduct data analysis. This activity is automatically monitored, tracked, and recorded by the platform to feed raw behavior to the metrics tool 60. The metrics tool 60 utilizes an assessment rubric, an example of which is shown in reference to FIG. 6. The ability of the metrics tool 60 to effectively capture useful raw behavior data is dependent on participants using the interface exclusively for tasks during the war game. Raw participant behavior data are the actions the participants take on the platform or when using one of the tools. For instance, if they are using the events manager tool 30, an example would be when they send a message or a document, and who they send it to. If they are using one of the analytical tools 90, such as the timeline tool 92, the raw participant behavior data is the order in which they place events on that timeline.

The present invention is a process to provide quantitative and qualitative evaluations of data analysis behavior and the management of.

Through the analytical management tool 70 participants may manage their access to information; organize teams; and manage team capabilities. The analytical management tool 70 provides an interface for the participants to access some of the same tools as the proctor does to create a session. It is separate from the events manager tool 30. Decisions made in the analytical management tool 70 are then enacted in the events manager tool 30. For instance, if a participant uses the analytical management tool 70 to request access to more information, then the scenario data database 40 will recognize that and pass more scenario data 41 through the events manager tool 30. However, if the participant wants to change the configuration of his or her team, then the request goes through the user database 80 and the effects are seen on the platform 10 rather than the events manager tool 30.

The analytical management tool 70 may be configured with a virtual wallet 71, which serves as a resource constraint for the participants within the training scenario. Conceptually, the wallet 71 may be considered to be one or more of time, money, a personnel resource pool, logistics, a training and readiness investment, and a research and development chain. In exchange for credits, representing an expenditure of time, personnel, money, and other resources, participants may obtain additional information access 72; modify team composition 72; and even change team capabilities during execution of the training scenario.

The user database 80 maintains data relating to authorized users of the system 10. The user database 80 may include the following functions: user access 81; user permissions 82; team access and permissions 83; and user accounts 84. The user database 80 may be accessed and modified by participants or proctors via the event manager tool 30 and the analytical management tool 70.

The user access 81 are conditions that determine what an individual user can see or modify. For instance, if a user access is marked as secret and unclassified, they can see documents with the classification of secret but not those with a classification of top secret.

The user permissions 82 is a list of actions that a user can take on the platform. For instance, a user can be given permission to send documents on the event manager tool 30 but the same user could be denied permission to use the RFI tool 50.

The team access and permissions 83 is a default list of accesses and permissions that a team has, similar to the user access 81 and user permissions 82. However, unlike user permissions 82, this function sets the same value for the entire team. Changes can still be made to individual users.

The user accounts 84 is where registered users' usernames, passwords and basic information are contained.

The analytical tools 90 are a suite of participant-accessible tools for arranging, combining, and interpreting scenario data 41. Through the analytical tools 90 they transform raw, fragmented information into a cohesive understanding of the events. For instance, they will be able to place events mentioned in three different pieces of scenario data into one place and in the right sequence or extract a narrative from five different reports that cover different aspects of the same situation. The analytical tools 90 receive scenario data 41 from the scenario database 40. The analytical tools 90 include an analytical judgments tool 91; a timeline tool 92; a hypothesis comparison tool 93; a geospatial tool 94, and a document analysis tool 95.

The analytical judgments tool 91 allows a user to review a scenario data and make judgements about what the data means or its significance. For instance, a judgement might be regarding the target of an attack; in that case, the user must select a value consistent with who they believed to be the target. This information becomes raw participant behavior data which is tracked by the metrics tool and compared to the correct answer in order to produce a score.

The timeline tool 92 provides the user a work space to order certain events and scenario data according to a temporal dispersion. For instance, four reports from the scenario data set contain dates ranging from six months ago to yesterday. The user can arrange those reports and dates on a graphical timeline from either oldest to newest or vice versa. This information becomes raw participant behavior data which is tracked by the metrics tool 60 and compared to the right sequence in order to produce a score.

The hypothesis comparison tool 93 provides a workspace for the user to formulate a hypothesis describing what they believe is happening in the scenario, who is doing it and what will happen next. The tool 93 allows the user to assess the validity of this hypothesis by arranging the scenario data as empirical evidence in either support or refutation of the hypothesis. The user will assign a numerical value to each piece of evidence, such as 5 for strongly support or negative 5 for strongly oppose and the totals will be tallied up. In this way, the user can create multiple hypotheses, score them in a structured manner, and compare those scores to determine which hypothesis is most accurate. This information also becomes raw participant behavior data which is tracked by the metrics tool 60.

The geospatial tool 94 allows users to place scenario data on a map in order to determine locations and spatial relationships. For instance, certain items of scenario data might have coordinates or specified locations such as a city or an address. The tool 94 allows the user to place these reports and the associated locations on a map and to analyze potential relationships such as distance and connectivity. This information becomes raw participant behavior data which is tracked by the metrics tool 60 and compared to the correct answers in order to produce a score.

The document analysis tool 95 allows users to sort, filter, rank, and arrange the scenario data in order to determine which reports are important. The tool 95 allows the user to select what part of the data is displayed, assign a priority to the individual scenario data items, and designate them for other tools within the analytical tool suite 90. The metrics tool 60 records this activity as raw participant data, including time spent on reports, filtering methods, prioritization, and which reports are passed to which analytical tools. The analytical tools suite 90 passes the raw participant behavioral data to the metrics module 60.

Since the simulation may be contained entirely in a contained online environment, participant activity can be tracked, measured, and monitored autonomously so as to provide more scientific and quantifiable results for use in process improvement. Thus, participants can manage the data analysis process by configuring their teams and improving their access to the data through the analytical management tool 70. To this end, they are given virtual tokens in order to purchase elements such as additional personnel, additional data streams, access to previously restricted data, simulated enhanced collection methods, simulated outside expertise, etc. However, these tokens are finite and the participants are challenged to spend them judiciously in order to maximize their impact and to not waste their effect.

The present invention further takes the burden off the proctors by streamlining assessment data collection, eliminating much of the variance caused by inconsistencies between proctor personnel.

Referring now to FIGS. 1 through 4, the present invention may include the following steps:
1. Scenario rules, rubric, and other documentation 42, scenario data 41, and stored in the scenario database 40;
2. Scenario rubric and scenario data are uploaded onto the scenario database 40 (if the scenario is not employing an existing scenario data);
3. A Scenario event timeline is crafted on the event manager tool 30, including the timed distribution of scenario data;
4. User accounts created for participants in a user database 80;
5. Participant teams and roles assigned by proctor through the user access 81; user permissions 82; team access and permissions 83;
6. Session initiated by proctor through event manager tool 30;
7. Events manager tool 30 distributes documents and conducts events as per the scenario timeline;
8. Participants organize their teams 73, granting new access 72 and adjust team capabilities 74 by spending virtual credits with a virtual wallet 71 through the analytical management tool 70 interface;
9. Proctors and participants communicate through the event manager tool 30;
10. Participants submit request further information (RFI) tickets through the RFI submission interface 51 of the RFI tool 50;
11. RFI tracker 51 records and updates RFI status and content, including proctor responses;
12. Metrics tool 60 interface times and tracks various participant analytical and communication activities for the assessment rubric;
13. Proctor can modify, pause, or manipulate timed events via a kill switch 33 while a session is in progress;
14. Proctor can deny access to any participant at any time for rules infraction or as a simulated stressor, which may be implemented via a kill switch 33;
15. Proctor ends the session through the events manager tool 30;
16. Platform assembles metrics by the metrics tool 60 for assessment against rubric;
17. Proctor reviews automated rubric metrics, makes any changes or annotations, and adds qualitative assessments; and
18. Proctor conduct an after action review for participants.

The events manager tool 30 is used to arrange scenario data 41 from the scenario data database 40 for a given war game session and to set a timetable for the iteration. The events manager tool 30, user database 80, request for information tool 50, analytical management tool 70, metrics tool 60, session management tool 20, and analytical tools 90 may all be components of the interface. The ability of the metrics tool 60 to effectively capture useful behavior data on the events tool 30, RFI tool 50, analytical management tool 70, and analytical tool 90 is dependent on participants using the platform 10 exclusively for tasks during the war game.

The participants are subjected to time and other stressors while they attempt to decipher the information presented to them to predict adversary actions and other events. This is managed by the event manager tool 30 in terms of ending and starting the game or through the kill switches 33. The platform 10 automates the process of passing information as well as serving as a way to track and record participant behavior, analytical methodology, communication between participants, and manage the introduction of supplemental or new information.

Proctors can apply a qualitative assessment of participants through their own interaction or review of the events manager tool 30, RFI tool 50, analytical management tool 70, and analytical tools 90, and the metrics tool 60. Participants are judged not only on their ability to provide the right answers, but also how they conducted their analysis and how effectively they communicated it. In this way, the present invention, through its automated process, provides both an assessment and training tool for organizations and individuals who must deal with data analysis. Participants use the platform 10 to conduct their data analysis, which in turn are monitored, tracked, and recorded by the platform 10.

Participants in iterations of the war game are evaluated on their current skill level or trained to a desired skill level. The present invention helps organizations understand their current competence levels and determine corrective training or measures to improve their ability to ingest and analyze information for a variety of applications including intelligence analysis, cyber security, crisis response, economic forecasting, etc. The present invention can be used in any situation in which an organization is impacted by a complex and heterogeneous data set and is seeking to improve its ability to respond, react, and understand a given situation vis-a-vis that data. The present invention is flexible enough to be configured to simulate complex and heterogeneous data in a way which participants analyze it and communicate with each other effectively in order to deal with situations.

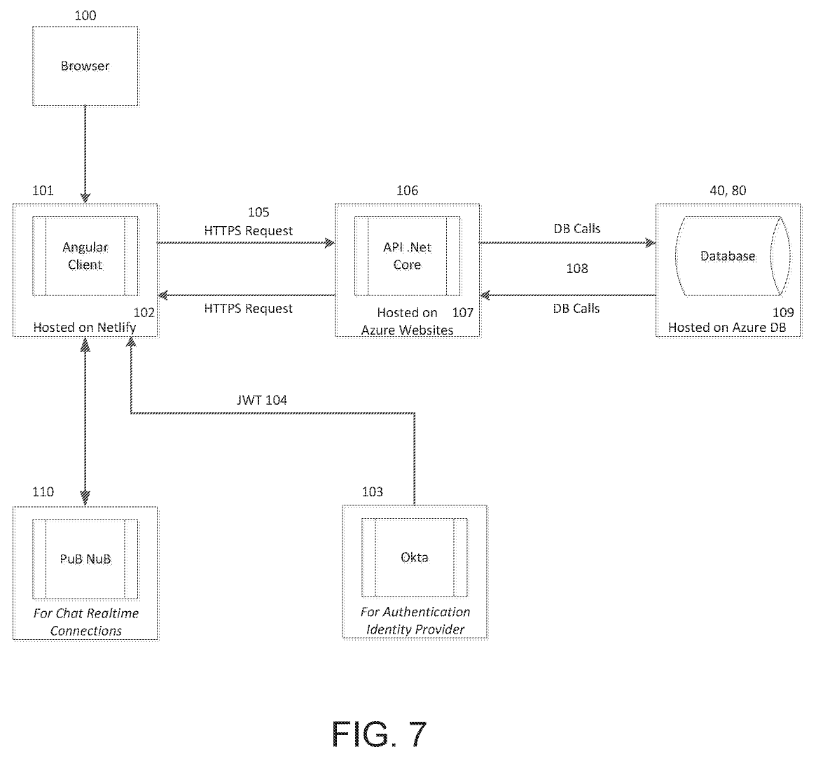

Referring to FIGS. 1-4 and 7, a method and representative communications infrastructure for implementing the present invention may include the following elements:
1. The user accesses the application from their device browser at a specified URL address.
2. The browser loads a JavaScript web development framework client 101 such as an Angular client side code from a content delivery network (CDN) 102, that is implemented in a distributed network of proxy servers and data centers, such as a Netlify CDN. If the client side code 101 has been fetched before and it is the same version, then a cached version is used.
3. When the user tries to access a protected page or resource in the Angular application 101, the application 101 redirects the user to a Login page. Each participant/proctor browser is configured with the Angular client 101 and the game environment runs within that. Holistically, all the active interfaces of the given session are the game platform including the hosted elements, server side API (control and synchronization) 106, database (configuration storage) (Azure) 40, 80, 109, PubNub (communication, tagging and timelines) 110.
4. Once the user provides a Username and Password they are securely sent over to an authentication identity service provider 103, such as provided by Okta, for authentication validation. OKTA authentication occurs at user login and if the challenge and provided credentials are successful then, it connects to the session manager tool 20. The user interface e.g. the RFI tool 50, analytical management tool 70 are related to an associated session. If validated successfully, the authentication identity service provider sends a JSON Web Token (JWT) 104, a signed id token and/or access token for claims transactions, back to the JavaScript web development framework client 101, the Angular client.
5. The Angular client 101 sends an HTTP request 105 to a custom application program interface (API) 106, which may be hosted on a cloud service provider site 107, such as an Azure Website, by Microsoft Corp. Each HTTP request 105 includes the JWT access token 104 provided in Step 4.
6. The (API) 106 validates the JWT access token 104 with the authentication identity service 103 and provides a response with the requested resources back to the JavaScript web development framework 101 client Angular Client. If the requested resources depend on the database 40, 80 then the API 106 makes calls 108 to the Database 40, 80 that may be hosted on Azure Database servers 109.
7. For all real-time communications, such as a chat functionality, the Angular Client 101 sends and receives messages using an external real-time communication service provider 110, such as PubNub.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computerized system for use by a data analysis and information handling training system to provide a quantitative assessment of data analysis and information handling operations of a team over a network platform, comprising:
a computer having a user interface;
a scenario database storing scenario data defining an exercise scenario and a corpus of non-machine processable information;
an event manager tool, configured to provide an interface with the scenario database;
a request for information (RFI) tool, configured to receive a plurality of requests for information (RFIs) from a participant during the training scenario;
an analytical management tool providing an interface through which the participant can adjust one or more of an access level to the scenario data, a team composition; and a team capability;
an analytical tools suite, configured to provide the participant one or more tools for analyzing the scenario data; and
a metrics tool, configured to receive raw participant data reflecting an action the participant takes with each of the event manager tool, the RFI tool, the analytical management tool, and the analytical tools suite, and automatically providing the quantitative assessment of the data analysis and information handling operations of the team.

2. The computerized system of claim 1, wherein the event manager tool further comprises:
an interface to allow a proctor to provide the scenario data;
one or more kill switches to control the exercise scenario; and
a communications interface configured to manage communications within the exercise scenario.

3. The computerized system of claim 1, wherein the analytical tools suite further comprises:
a timeline tool configured to provide a work space to order the scenario data according to a temporal sequence.

4. The computerized system of claim 1, wherein the analytical tools suite further comprises:
a hypothesis comparison tool configured to provide a workspace for the participant to formulate a hypothesis and assess a validity of the hypothesis by arranging the scenario data as empirical evidence in support or refutation of the hypothesis.

5. The computerized system of claim 4, wherein the hypothesis comparison tool provides an interface for the participant to assign a numerical value to each piece of a relevant scenario data element, determine a score of the hypothesis in a structured manner, and compare the score to determine which of a plurality of hypotheses is most accurate.

6. The computerized system of claim 1, wherein the analytical tools suite further comprises:
a geospatial tool configured to allow the participant to place one or more scenario data elements on a map in order to determine one of a location and a spatial relationship between the one or more scenario data elements.

7. The computerized system of claim 1, wherein the analytical tools suite further comprises:
a document analysis tool configured to allow participants to sort, filter, rank, and arrange the scenario data.

8. The computerized system of claim 7, wherein the document analysis tool further comprises:
an interface configured for the participant to select a part of one or more scenario data to be displayed, assign a priority to the one or more scenario data elements, and designate the one or more scenario data elements for processing by one or more other tools within the analytical tool suite.

9. The computerized system of claim 1, wherein the analytical management tool further comprises:
a virtual wallet, configured to decrement a predetermined credit value for a change in one or more of an access level to the scenario data, a composition of the team; and a team capability.

10. The computerized system of claim 1, wherein the network platform comprises:
a JavaScript web development framework client in communication with a content delivery network (CDN) implemented in a distributed network of proxy servers and data centers.

11. The computerized system of claim 1, wherein the network platform further comprises:
an authentication identity service provider configured to provide a JSON Web Token (JWT) as an identity authentication.

12. The computerized system of claim 11, wherein the network platform further comprises:
an application program interface (API), hosted on a cloud service provider site, configured to coordinate a plurality of HTTP requests and the JWT access token for each of the plurality of HTTP requests.

13. The computerized system of claim 1, further comprising:
a real-time communications functionality provided by an external real-time communication service provider.
